(19) United States
(12) Patent Application Publication
(10) Pub. No.: US 2023/0085737 A1
(43) Pub. Date: Mar. 23, 2023

(54) POWER CONVERSION CIRCUIT

(71) Applicant: Delta Electronics (Shanghai) Co.,Ltd., Shanghai (CN)

(72) Inventors: Haijun YANG, Shanghai (CN); Yuxi WANG, Shanghai (CN); Kaijun ZHU, Shanghai (CN); Zengyi LU, Shanghai (CN)

(21) Appl. No.: 17/933,123

(22) Filed: Sep. 19, 2022

(30) Foreign Application Priority Data
Sep. 22, 2021 (CN) 202111105872.0

(51) Int. Cl. H01F 30/12; H01F 27/24; H02M 1/42; H01F 27/28; H02M 7/537

(52) U.S. Cl. CPC H01F 30/12; H01F 27/24; H02M 1/4258; H01F 27/2823; H02M 7/537

(57) ABSTRACT

Disclosed is a power conversion circuit, comprising a three-phase inductor and a switching conversion unit, and the three-phase inductor is integrated into a magnetic assembly, the magnetic assembly comprising: two magnetic yokes relatively parallel to each other; a first, a second and a third winding column spaced apart sequentially and located between the two magnetic yokes, and three windings wound around the first, the second and the third winding column in one-to-one correspondence for forming an phase inductor of the three-phase inductor respectively, and phase differences between power frequency currents flowing in any two of the windings are 120°; wherein when a reference current is applied to each of the windings, magnetic fluxes on the first and the third winding column have a first reference direction, and a magnetic flux on the second winding column has a second reference direction opposite to the first reference direction.

### CROSS-REFERENCE TO RELATED APPLICATIONS

This non-provisional application claims priority under 35 U.S.C. § 119(a) on Patent Application No. 202111105872.0 filed in P.R. China on Sep. 22, 2021, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The application relates to the field of power electronics technology, and particularly to a power conversion circuit.

### 2. Related Art

As for three-phase circuits in the field of power electronics technology, in addition to switches, control chips and other components, a certain number of capacitors and inductors are often included, for example, inverter inductors in a three-phase inverter circuit or power factor correction (PFC) inductors in a three-phase PFC circuit. In the conventional method, three separated inductors are connected to three-phase branches respectively. At this point, a volume and weight of a magnetic element are large, and in order to reduce the volume, weight and cost of the inductors, an integrated inductor having a three-phase three-column structure or a three-phase five-column structure is further developed.

In the existing integrated inductor with a three-phase three-column structure, for the pursuit of a vector sum of power frequency currents (i.e., a frequency of power grid is 50 Hz or 60 Hz, and also may have a certain deviation, such as, +/−2 Hz and the like, so the details are not described below) of the three-phase is 0 (so a vector sum of power frequency magnetic fluxes of the three-phase on three winding magnetic columns is also 0), three windings on the winding columns often use the same winding method or wire wrapping method, so reference magnetic flux directions of the three windings are the same. That is, at the same time, in the case that the power frequency currents of the three-phase flowing the three windings are balanced, the vector sum of the power frequency magnetic fluxes is 0, but since components of high-frequency magnetic flux formed by turning on/off actions of switches in the three phases do not have a fixed time sequence relation, the vector sum cannot remain 0, causing large ripple current in each winding of the inductors.

In addition, in the existing integrated inductor with a three-phase five-column structure, a magnetic core comprises three winding columns and two non-winding columns, and the two non-winding columns can be respectively disposed between any two adjacent winding columns (i.e., “built-in”), and also can be respectively disposed on two outer sides of the three winding columns (i.e., “external”). No matter whether it is a “built-in” or an “external” scheme, the existing three winding columns are nearly decoupled from each other. That is, the non-winding columns are often set to be decoupling columns, and as magnetic fluxes of the decoupling columns are large, a volume of decoupling columns is also large correspondingly. The decoupling columns are often magnetic columns without air gaps or distributed air gaps, and often use magnetic core material with a high magnetic permeability, i.e., the non-winding columns provide equivalent magnetic circuits with low magnetic reluctance. If the decoupling columns use an alloy powder core material with a low magnetic permeability, the problem of the large ripple current also cannot be avoided.

To sum up, in design of the existing three-phase inductor, regardless of independent elements or integrated elements, there are certain deficiencies exist. The independent elements have a large volume and a heavy weight, while the integrated inductor with a three-phase three-column structure has a small equivalent inductance, causing a large current ripple, and reference directions of the magnetic fluxes formed by the three windings of the three-phase five-column integrated inductor are also consistent. Moreover, the non-winding columns are decoupling columns using materials with a high magnetic permeability, causing that application is limited, and design of the magnetic elements is not flexible enough.

### SUMMARY OF THE INVENTION

An object of the application is to provide a novel power conversion circuit using an integrated inductor, which can solve one or more deficiencies in the prior art.

To realize the object, according to one embodiment of the application, the application provides a power conversion circuit, comprising a three-phase inductor and a switching conversion unit, a first end of an inductor in each phase of the three-phase inductor electrically coupled to a midpoint of a bridge arm in one phase of the switching conversion unit, a second end of the inductor in each phase of the three-phase inductor electrically coupled to one phase of a three-phase AC power source, and the three-phase inductor is integrated into a magnetic assembly, comprising: two magnetic yokes relatively parallel to each other; a first, a second and a third winding column spaced apart sequentially and located between the two magnetic yokes, the second winding column located between the first and the third winding column; and three windings wound around the first, the second and the third winding column in one-to-one correspondence for forming the inductor in one phase of the three-phase inductor respectively, and phase differences between power frequency currents flowing in any two of the three windings are 120°; wherein when a reference current is applied to each of the three windings, the reference current flows in from the first end of each of the three windings and flows out from the second end, magnetic fluxes excited by the reference current on the first and the third winding column have a first reference direction, and a magnetic flux excited on the second winding column has a second reference direction, wherein the second reference direction is opposite to the first reference direction.

The power conversion circuit of the application reconstructs a coupling relation between the three windings of the integrated inductor, and can significantly reduce current ripples on branches of the respective phases by setting the windings on the adjacent magnetic columns to be coupled with reference to a forward direction, and the windings on the spaced magnetic columns to be coupled with reference to a reverse direction, i.e., setting a reference magnetic flux direction of the middle winding column to be opposite to a reference magnetic flux direction of other winding columns.

The integrated inductor in the power conversion circuit of the application can achieve good application effects by, for example, using the material of alloy powder core (namely a core material containing naturally distributed air gaps, such as High Flux, Kool mu, and the like), and integration of three-phase five-column scheme. In addition, design of the application is also more flexible.

The additional aspects and advantages of the application are partially explained in the below description, and partially becoming apparent from the description, or can be obtained through the practice of the application.

### BRIEF DESCRIPTION OF THE DRAWINGS

The exemplary embodiments are described in details with reference to the accompanying drawings, through which the above and other features and advantages of the application will become more apparent.

FIG. 1 is a topology diagram of a power conversion circuit.

FIGS. 2A and 2B are schematic diagrams of phase relations of power frequency currents flowing three inductor windings in the three-phase circuit of FIG. 1 and phase relations of power frequency magnetic fluxes formed therein.

FIG. 3A is a schematic diagram of a three-phase three-column integrated structure and windings thereof based on a three-phase inductor in the power conversion circuit of FIG. 1 using conventional method I.

FIG. 3B is a current waveform (dark sine portion is component of power frequency, the remaining is component of ripples, and details are not described below) flowing in a B-phase inductor and a voltage waveform between two points BBO in the three-phase inductor of FIG. 3A.

FIG. 4A is a schematic diagram of a built-in three-phase five-column integrated structure and windings thereof based on the three-phase inductor in the power conversion circuit of FIG. 1 using conventional method II.

FIG. 4B is a current waveform flowing in a B-phase inductor and a voltage waveform between two points BBO in the three-phase inductor of FIG. 4A.

FIG. 5 is a schematic diagram of an external three-phase five-column integrated structure and windings thereof based on the three-phase inductor in the power conversion circuit of FIG. 1 using conventional method III.

FIG. 6A is a schematic diagram of a structure and wirings of a magnetic assembly using a three-phase three-column integrated inductor in an embodiment I of the power conversion circuit of the application.

FIG. 6B is a current waveform flowing in a B-phase inductor and a voltage waveform between two points BBO in the three-phase inductor of FIG. 6A.

FIG. 7 is a schematic diagram of a structure and windings of the three-phase inductor using a three-phase four-column integrated inductor in an embodiment II of the power conversion circuit of the application.

FIG. 8A is a schematic diagram of a structure and windings of the three-phase inductor using a built-in three-phase five-column integrated inductor in an embodiment III of the power conversion circuit of the application.

FIG. 8B is a current waveform flowing in a B-phase inductor and a voltage waveform between two points BBO in the three-phase inductor of FIG. 8A.

FIG. 9 is a schematic diagram of a structure and windings of the three-phase inductor using an external three-phase five-column integrated inductor in an embodiment IV of the power conversion circuit of the application.

### DETAILED EMBODIMENTS OF THE INVENTION

The exemplary embodiments will now be described more fully with reference to the accompanying drawings. However, the exemplary embodiments can be implemented in various forms and shall not be understood as being limited to the embodiments set forth herein; on the contrary, these embodiments are provided so that this application will be thorough and complete, and the conception of exemplary embodiments will be fully conveyed to those skilled in the art. In the drawings, the same reference sign denotes the same or similar structure, so their detailed description will be omitted.

When factors/components/the like described and/or illustrated here are introduced, the phrases “one”, “a(an)”, “the”, “said” and “at least one” refer to one or more factors/components/the like. The terms “include”, “comprise” and “have” refer to an open and included meaning, and refer to additional factors/components/the like may exist in addition to the listed factors/components/the like. The embodiments may use relative phrases, such as, “upper” or “lower” to describe a relative relation of one signed component over another signed component. It shall be understood that if the signed device is turned upside down, the described component on an “upper” side will become a component on a “lower” side. In addition, the terms “first”, “second” and the like in the claims are only used as signs, instead of numeral limitations to objects.

FIG. 1 shows a power conversion circuit 100 in the application, such as, a three-phase inverter circuit, comprising a three-phase inductor 10 and a switching conversion unit 20. A first end of an inductor in each phase of the three-phase inductor 10 may be electrically coupled to a midpoint of a bridge arm in one phase of the switching conversion unit 20, and a second end of the inductor in each phase of the three-phase inductor 10 may be electrically coupled to one phase of a three-phase AC power source 30. For example, in illustration of FIG. 1, the three-phase inductor 10 comprises a phase A inductor L_{A}, a phase B inductor L_{B} and a phase C inductor L_{C}. The switching conversion unit 20 comprises three bridge arms, and each may include upper and lower switches, such as, a phase A bridge arm including switches S1 and S4, a phase B bridge arm including switches S2 and S5, and a phase C bridge arm including switches S3 and S6. Of course, each bridge arm also can include three or more switches, and the bridge arm also can be a three-level or multi-level bridge arms, but the application is not limited thereto. A first end a₁ of the phase A inductor L_{A} is electrically coupled to a midpoint AA (i.e., a midpoint between the switches S1 and S4) of the phase A bridge arm in the switching conversion unit 20, and a second end a₂ of the phase A inductor L_{A} is electrically coupled to a phase A Uga of the three-phase AC power source 30; a first end b₁ of the phase B inductor L_{B} is electrically coupled to a midpoint BB (i.e., a midpoint between the switches S2 and S5) of the phase B bridge arm in the switching conversion unit 20, and a second end b₂ of the phase B inductor L_{B} is electrically coupled to a phase B Ugb of the three-phase AC power source 30; a first end c₁ of the phase C inductor L_{C} is electrically coupled to a midpoint CC (i.e., a midpoint between the switches S3 and S6) of the phase C bridge arm in the switching conversion unit 20, and a second end c₂ of the phase C inductor L_{C} is electrically coupled to a phase C Ugc of the three-phase AC power source 30.

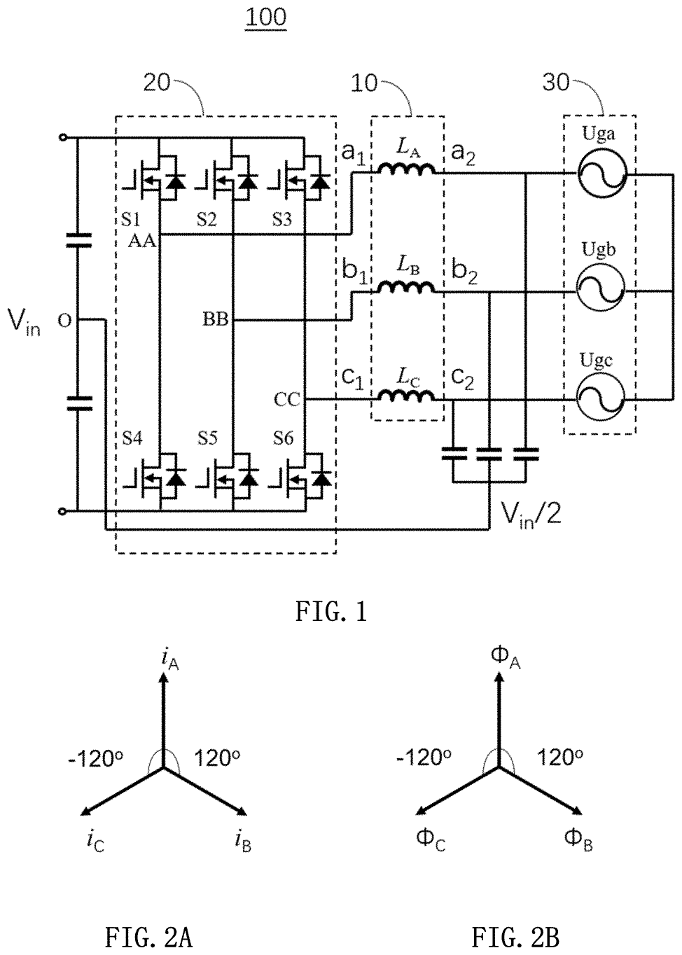

In the application, phase relations of three-phase power frequency sine currents and phase relations of power frequency magnetic fluxes formed therein are shown in FIGS. 2A and 2B. Phases of the three-phase power frequency sine currents i_{A}, i_{B}, i_{C} are interleaved with each other by 120°, and phases of the three-phase power frequency magnetic fluxes ϕ_{A}, ϕ_{B}, ϕ_{C} are also interleaved with each other by 120°. Generally, a vector sum of the three-phase power frequency sine currents is 0, i.e., i_{A}+i_{B}+i_{C}=0.

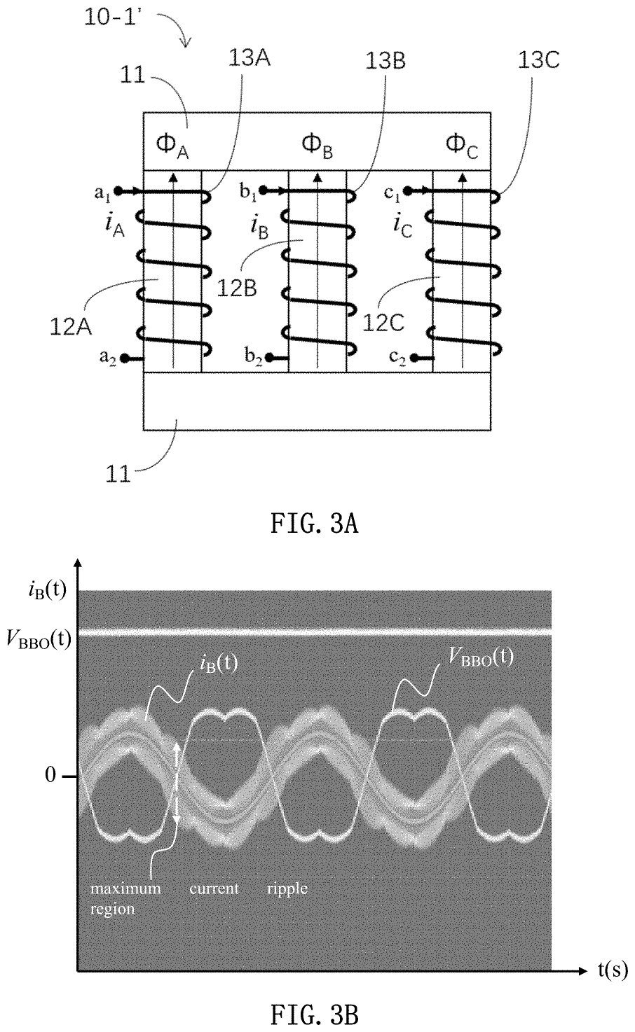

A schematic diagram of a three-phase three-column integrated structure 10-1′ and windings thereof based on a three-phase inductor in the power conversion circuit of FIG. 1 implemented by using a conventional method I is shown in FIG. 3A, and FIG. 3B shows a current waveform i_{B}(t) flowing in the phase B inductor and a voltage waveform V_{BBO}(t) between two points BBO. Considering of phase relations between the three-phase power frequency currents (as shown in FIG. 2), in order to make magnetic fluxes after composition of the three-phase power frequency currents be 0, the conventional method I allows reference magnetic flux directions in a three-phase magnetic circuit to be towards the same direction, such as, upward or downward, through the same winding method, and a reference coupling method between any two of three winding columns is negative coupling. In practice application, since high-frequency components of switches cannot always interleave with each other by an electrical angle of 120°, a magnetic flux of the high-frequency components after composition are not 0, causing large ripple of high-frequency currents. As shown in FIGS. 3A and 3B, the three winding columns 12A to 12C and two magnetic yokes 11 all use a same material of alloy powder core with a low μᵣ, wherein a sectional area of the winding columns is Aₑ₁=490 mm², a sectional area of the magnetic yokes is Aₑ₃=450 mm², the number of turns of three windings 13A to 13C is 52, and μᵣ of the alloy powder core is 60. In the three-phase integrated inductor, a self-inductance of the phase A inductor is L11=630 uH, a self-inductance of the-phase B inductor is L22=795 uH, a self-inductance of the phase C inductor is L33=638 uH, a mutual inductance between the phase A inductor and the phase B inductor is M12=−269 uH, a mutual inductance between the phase B inductor and the phase C inductor is M23=−276 uH, a mutual inductance between the phase A inductor and the phase C inductor is M13=−94 uH, an input voltage is Vᵢₙ=580V, an output voltage is V_{ac_rms}=210V, and a switching frequency is fₛ=40 kHz, so the details are not described below. When the conventional method I is used, i.e., the reference magnetic flux directions of the respective phases are set to be towards the same direction, such as, upward or downward at the same time, for example, at a certain time, an output voltage of the phase B is 0 (at this time, ripples of the phase B current is the maximum value in the whole power frequency cycle), i.e., V_{B}=0, then output voltages of the phase A and the phase C can be calculated to be V_{A}=257.5V and V_{C}=−257.5V, and voltages applied to the first and second ends of the inductors in the three-phase inductor are AL=+32.5V, BL=+290V, and CL=−32.5V, respectively. In such way, the maximum value of the current ripple actually measured on the phase B is 16.16 A, referring to maximum current ripple region in FIG. 3B.

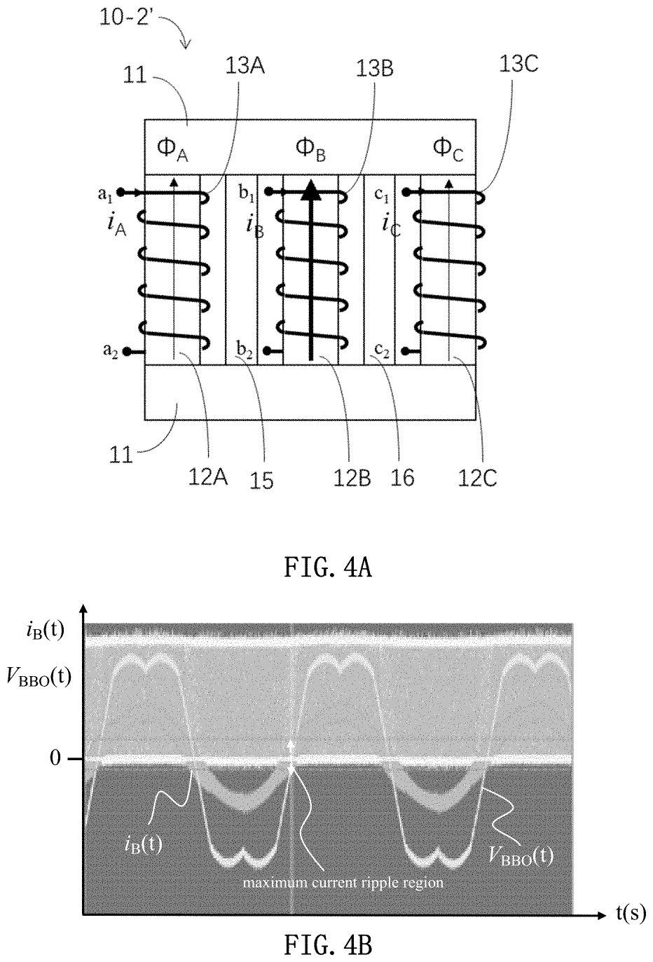

In addition, when a built-in three-phase five-column integrated inductor in a conventional method II is used, a schematic diagram of an inductor structure 10-2′ and windings thereof is shown in FIG. 4A, and FIG. 4B shows a current waveform i_{B}(t) flowing in the phase B inductor and a voltage waveform V_{BBO}(t) between two points BBO. In a winding method of the conventional method II, considering that a magnetic flux after vector composition of the three-phase power frequency is 0, reference magnetic flux directions are also set to be upward or downward at the same time, and non-winding columns often use decoupling magnetic columns with a high μᵣ, so the integrated inductor may be substantially equivalent to decoupling of three inductors, i.e., three discrete inductors. Using this scheme, a magnetic flux of the decoupling columns is often large, causing that a volume of the magnetic assembly is still very large, or a core material that can bear a higher Bₛ (i.e., a magnetic flux density) shall be used.

Please continue to refer to FIG. 4A, it is a structure of the built-in three-phase five-column integrated inductor in the conventional method II, wherein five magnetic columns (including winding columns 12A to 12C and additional columns 15 to 16) and two magnetic yokes 11 all use a same material of alloy powder core with a low μᵣ, wherein a sectional area of the winding columns is Aₑ₁=490 mm², a sectional area of the additional columns is Aₑ₂=308 mm², a sectional area of the magnetic yokes is Aₑ₃=450 mm², the number of turns of the three windings is 52, μᵣ of the alloy powder core is 60, a self-inductance of the phase A inductor is L11=704 uH, a self-inductance of the phase B inductor is L22=879 uH, a self-inductance of the phase C inductor is L33=705 uH, a mutual inductance between the phase A inductor and the phase B inductor is M12=−187 uH, a mutual inductance between the phase B inductor and the phase C inductor is M23=−194 uH, a mutual inductance between the phase A inductor and the phase C inductor is M13=−55 uH, an input voltage is Vᵢₙ=580V, and an output voltage is V_{ac_rms}=210V. When the reference magnetic flux directions of the respective phases are towards the same direction, such as, upward or downward at the same time, for example, at a certain time, an output voltage of the phase B is 0 (at this time, ripples of the phase B current is the maximum value in the whole power frequency cycle), i.e., V_{B}=0, then output voltages of the phase A and the phase C can be calculated to be V_{A}=257.5V and V_{C}=−257.5V, and voltages applied to the first and second ends of the inductors in the three-phase inductor are AL=+32.5V, BL=+290V, and CL=−32.5V, respectively. In such way, the maximum value of the current ripple on the phase B may refer to maximum current ripple region in FIG. 4B, and is 10.01 A.

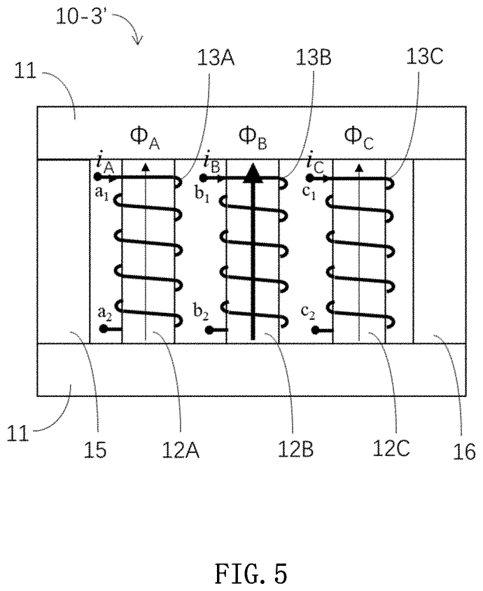

FIG. 5 is a schematic diagram of an external three-phase five-column integrated structure 10-3′ and windings thereof based on a three-phase inductor in the power conversion circuit using a conventional method III. In the conventional method III, considering that a magnetic flux after vector composition of the three-phase power frequency is 0, reference magnetic flux directions are also set to be upward or downward at the same time, and non-winding columns (i.e., additional columns 15 to 16) use decoupling magnetic columns with a high μᵣ, so the integrated inductor may be substantially equivalent to decoupling of three inductors, i.e., equivalent to three separate inductors. Using this scheme, a magnetic flux of the decoupling columns is often large, causing that a volume of the magnetic assembly is relatively large, or an iron core material that can bear a higher Bₛ shall be used.

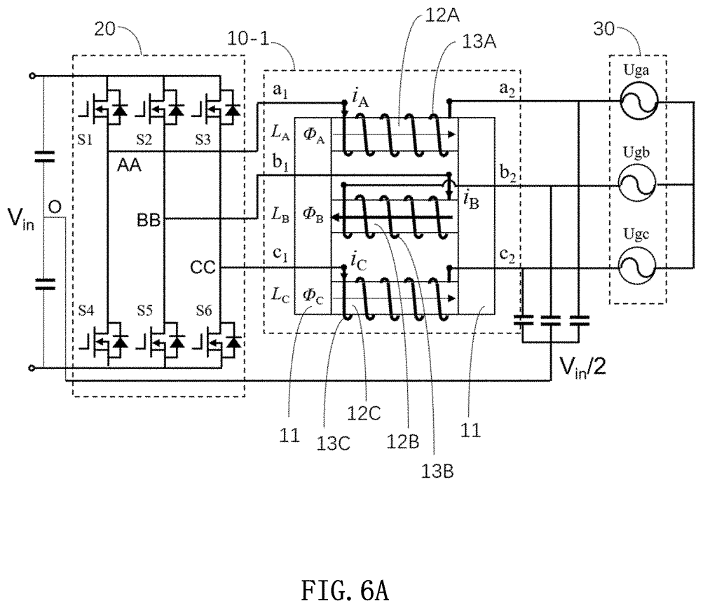

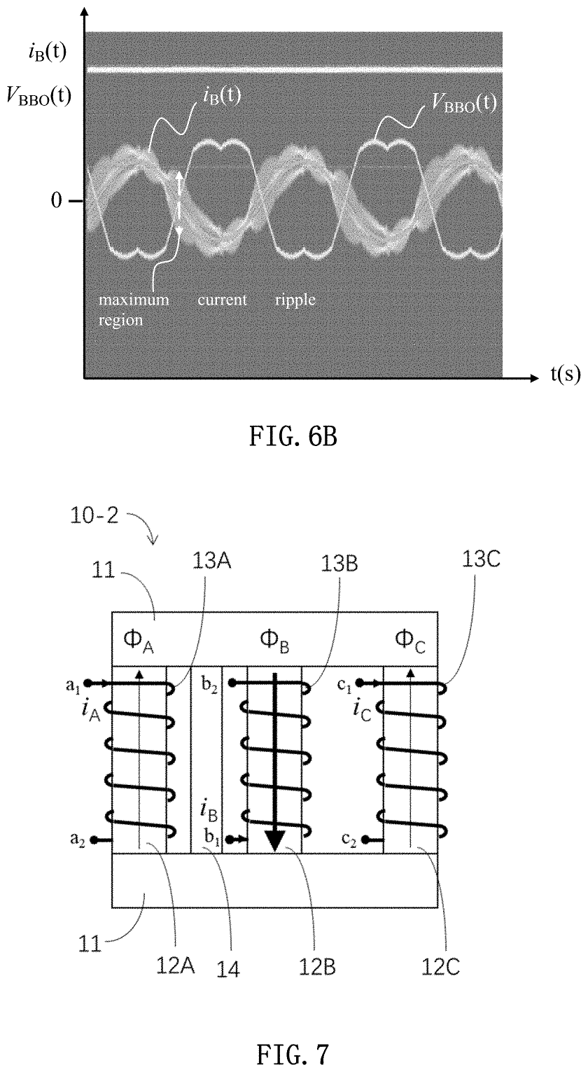

FIGS. 6A to 9 are some detailed embodiments of the application. A magnetic assembly, for example, is a three-phase three-column integrated inductor 10-1 and windings thereof, as shown in FIG. 6A, for example, comprising two magnetic yokes 11, three winding columns 12A to 12C, and three windings 13A to 13C. The two magnetic yokes 11 are relatively parallel to each other. The three winding columns 12A to 12C, for example, include a first winding column 12A, a second winding column 12B and a third winding column 12C spaced apart sequentially and located between the two magnetic yokes 11, and the second winding column 12B may be located between the first winding column 12A and the third winding column 12C. The three windings 13A to 13C are wound onto the first winding column 12A, the second winding column 12B and the third winding column 12C in one-to-one correspondence for forming an inductor in one phase of the three-phase three-column integrated inductor 10-1 respectively, and phase differences between power frequency currents flowing any two of the three windings 13A to 13C are 120°. For example, combining with FIG. 2, phases of a power frequency current i_{A} flowing in the winding 13A, a power frequency current i_{B} flowing in the winding 13B, and a power frequency current i_{C} flowing in the winding 13C are interleaved with each other by 120° sequentially according to time sequence in a power frequency cycle. Of course, in actual working conditions, the phase differences between the three-phase currents may have a certain deviation, such as, +/−3°. When a same reference current is applied to each of the three windings 13A to 13C, the reference current flows in from a first end (such as, a₁, b₁, c₁) of each of the three windings 13A to 13C and flows out from a second end (such as, a₂, b₂, c₂), magnetic fluxes ϕ_{A} and ϕ_{C} excited by the reference current on the first winding column 12A and the third winding column 12C have a first reference direction (toward right in the embodiment of FIG. 6A), and a magnetic flux ϕ_{B} excited on the second winding column 12B has a second reference direction (toward left in the embodiment of FIG. 6A), wherein the second reference direction is opposite to the first reference direction. It shall be noticed that different reference magnetic flux directions of the three windings are realized through different winding methods or different winding connection method of the three windings, i.e., a method of connecting different winding of the three-phase inductor to a switching conversion unit and a power source respectively, and feature of the above reference magnetic fluxes is generated only when the same reference current flows in the three windings, not when real three-phase currents are connected in actual working conditions. Further, the application intends to reconstruct a coupling relation between the three-phase windings of the integrated inductor by designing a new winding method of the windings: setting positive coupling between the phases A and B, and positive coupling between the phases B and C, while negative coupling between the phases A and C (which is different from negative coupling between any two of the phases A, B and C in the conventional method I). As shown in FIGS. 6A and 6B, FIG. 6B is a current waveform i_{B}(t) flowing in the phase B inductor and a voltage waveform V_{BBO}(t) between two points BBO in the three-phase inductor of FIG. 6A, and parameters of the integrated magnetic assembly may refer to FIG. 3A. That is, a sectional area of the winding columns is Aₑ₁=490 mm², a sectional area of the magnetic yokes is Aₑ₃=450 mm², the number of turns of the three windings is 52, and μᵣ of the alloy powder core is 60; in the three-phase integrated inductor, a self-inductance of the phase A inductor is L11=630 uH, a self-inductance of the phase B inductor is L22=795 uH, a self-inductance of the phase C inductor is L33=638 uH, a mutual inductance between the phase A inductor and the phase B inductor is M12=+269 uH, a mutual inductance between the phase B inductor and the phase C inductor is M23=+276 uH, a mutual inductance between the phase A inductor and the phase C inductor is M13=−94 uH, an input voltage is Vᵢₙ=580V, and an output voltage is V_{ac_rms}=210V. After the scheme of above-mentioned reconstruction of coupling method in the application, i.e. the new winding method, is used, for example, an output voltage of the phase B is zero (at this time, ripples of the phase B current is the maximum value in the whole power frequency cycle), i.e., V_{B}=0, then output voltages of the phase A and the phase C can be calculated to be V_{A}=257.5V and V_{C}=−257.5V, and voltages applied to the first and second ends of each inductor in the three-phase inductor are AL=32.5V, BL=290V, and CL=−32.5V, respectively. At this time, a calculated value of the current ripple on the phase B may be obtained by formula I, and is ΔI_{B}=i_{B}/fₛ=12.27 A, which is substantially and completely consistent with a ripple value of 12.3 A actually measured, as shown in maximum current ripple region in FIG. 6B (it shall be noticed that whether signs before values of mutual inductance in formula I are positive or negative is associated with voltages on ends of the windings, 1. If a first end of the inductor is positive, and a second end is negative, the voltage may be defined to be positive, 2. Similarly, if the first end of the inductor is negative, and the second end is positive, the voltage is defined to be negative, so when AL=32.5V, BL=290V, and CL=−32.5V, voltages on the phase A and the phase B are positive, which are the same as the reference defined positive coupling, i.e., positive coupling +M12, the phase B is positive and the phase C is negative, which are the reverse of the reference defined positive coupling, i.e., negative coupling −M23, the phase A is positive and the phase C is negative, which are the reverse of reference defined negative coupling, i.e., positive coupling +M13, and other exemplary analysis methods are the same, so the details are not described). As compared to the conventional method I, the ripple current is largely reduced (when the conventional method I is used, the current ripple on the phase B also can be calculated from formula I, ΔI_{B}′=i_{B}′/fₛ=15.42 A, and the maximum current ripple actually measured is 16.16 A, so the calculated value and the actually measured value are also substantially and completely consistent).

L11·i1+M12·i2+M13—i3=AL

L22·i2+M12·i1+M23·i3=BL

L33·i3+M13·i1+M23·i2=CL Formula I

In some embodiments of the application, the first winding column 12A, the second winding column 12B and the third winding column 12C, for example, may be made of alloy powder core with a low magnetic permeability (such as, High Flux, Kool mu, etc., for example uᵣ<200), or a material with high magnetic permeability containing air gaps (such as, ferrite, amorphous or nanocrystal material, etc., for example uᵣ>500). In some other embodiments of the application, the two magnetic yokes 11, the first winding column 12A, the second winding column 12B and the third winding column 12C, for example, may be made of alloy powder core with a low magnetic permeability (such as, High Flux, Kool mu, etc., for example uᵣ<200), or a material with high magnetic permeability containing air gaps (such as, ferrite, amorphous or nanocrystal material, etc., for example uᵣ>500).

In some embodiments of the application, the three windings 13A to 13C can be wound around the first winding column 12A, the second winding column 12B and the third winding column 12C in the same manner.

In some embodiments of the application, the power conversion circuit 100, for example, may be an inverter circuit or a power factor correction circuit. However, it can be understood that although the embodiment of FIG. 1 is explained by taking a circuit topology of the three-phase inverter circuit as an example, the specific circuit topology of the power conversion circuit in the application also can have some differences from the topology shown in the figure without departing from basic concept of the application.

In one embodiment of the application, the magnetic assembly and windings thereof, for example, may be a three-phase four-column integrated inductor 10-2, as shown in FIG. 7, and differ from the embodiment of FIG. 6A in that the magnetic assembly further comprises an additional column 14 located between the two magnetic yokes 11. In the embodiment of FIG. 7, the additional column 14, for example, is located between the first winding column 12A and the second winding column 12B. However, it can be understood that in other embodiments, the additional column 14 also can be located between the second winding column 12B and the third winding column 12C, but the application is not limited thereto. In this embodiment, the additional column 14, for example, may be made of alloy powder core, and a relative magnetic permeability of the alloy powder core may be less than or equal to 200, and it may be High Flux or Kool mu, etc. In other embodiments, the additional column 14 also may be made of a material with high magnetic permeability containing air gaps, and a relative magnetic permeability of the material with high magnetic permeability may be greater than or equal to 500.

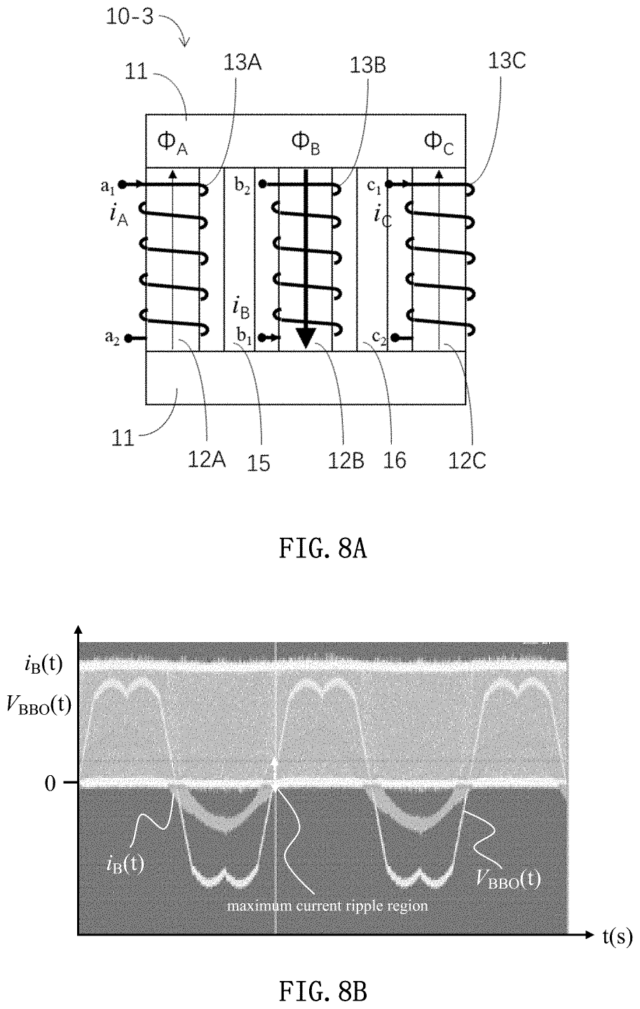

In another embodiment of the application, the magnetic assembly and windings thereof, for example, may be a built-in three-phase five-column integrated inductor 10-3, as shown in FIG. 8A, and differ from the embodiment of FIG. 4A in that the magnetic assembly further comprises a first additional column 15 disposed between the first winding column 12A and the second winding column 12B, and a second additional column 16 disposed between the second winding column 12B and the third winding column 12C.

When the scheme of reconstruction of a three-phase coupling relation in the application is used, i.e., the reference magnetic flux direction set by the phase B is opposite to that of phases A and C, and the maximum current ripple on the phase B may be reduced from 10.01 A to 8.76 A, as shown in maximum current ripple region in FIG. 8B.

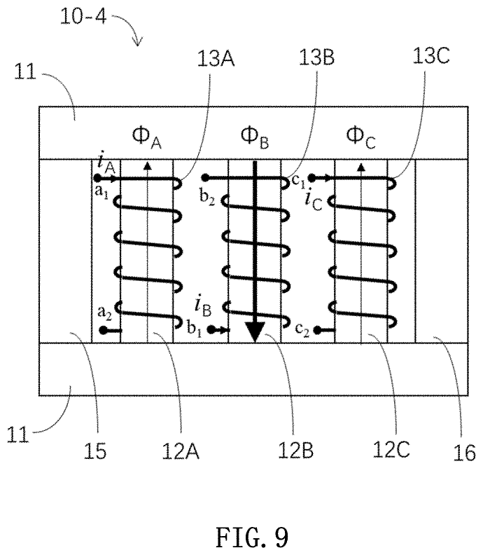

In still another embodiment of the application, the magnetic assembly, for example, also may be an external three-phase five-column integrated inductor 10-4, as shown in FIG. 9, and differ from the embodiment of FIG. 8A in that a first additional column 15 is disposed on an outer side of the first winding column 12A, and a second additional column 16 is disposed on an outer side of the third winding column 12C.

In the embodiments shown in FIGS. 8A and 9, the first additional column 15 and the second additional column 16, for example, may be made of alloy powder core, and a relative magnetic permeability of the alloy powder core may be less than or equal to 200. In other embodiments, the first additional column 15 and the second additional column 16 also may be made of a material with high magnetic permeability containing air gaps, and a relative magnetic permeability of the material with high magnetic permeability may be greater than or equal to 500.

In different winding methods, the maximum value of magnetic flux densities at each position of the integrated inductor with a built-in three-phase five-column structure are analyzed. In the integrated inductor with the three-phase five-column structure, a sectional area of the winding columns is Aₑ₁=490 mm², a sectional area of the additional columns is Aₑ₂=240 mm², a sectional area of the magnetic yokes is Aₑ₃=450 mm², and the additional columns are made of alloy powder core with a low magnetic permeability or a material with high magnetic permeability containing air gaps; B_{maxA1}, B_{maxB1} and B_{maxC1} are the maximum magnetic flux densities on the three winding columns when the three windings from left to right are connected with three-phase currents correspondingly; B_{maxAB} and B_{maxBC} are the maximum magnetic flux densities on the first additional column and the second additional column from left to right in the built-in three-phase five-column integrated inductor; B_{maxA2} is the maximum magnetic flux density on the magnetic yoke between the left winding column and the first additional column; B_{maxB2} is the maximum magnetic flux density on the magnetic yoke between the first additional column and the middle winding column or the maximum magnetic flux density on the magnetic yoke between the middle winding column and the second additional column; B_{maxC2} is the maximum magnetic flux density on the magnetic yoke between the second additional column and the right winding column. As shown in Table 1, as can be known from comparison, the winding methods of A⁺B⁻C⁺, B⁺A⁻C⁺or A⁺C⁻B⁺according to the reference magnetic flux directions on the three winding columns are optimal selections, i.e., irrelevant to mounting positions of the three windings of the three phases A, B and C on the three winding columns, and only need to set the winding method of the middle winding column of the integrated inductor such that the reference magnetic flux direction thereon is opposite to the reference magnetic flux directions formed by the winding methods of the other two winding columns.

TABLE 1
Maximum magnetic flux densities at each position of
the integrated inductor in different winding methods

| Three-phase | | | | | | | | |
|---|---|---|---|---|---|---|---|---|
| winding schemes | B_{maxA1} | B_{maxA2} | B_{maxAB} | B_{maxB1} | B_{maxB2} | B_{maxBC} | B_{maxC1} | B_{maxC2} |
| A⁺B⁺C⁺ | 0.780T | 0.693T | 0.383T | 0.910T | 0.584T | 0.383T | 0.780T | 0.695T |
| A⁺B⁺C⁻ | 0.763T | 0.679T | 0.585T | 0.861T | 0.63/0.30 | 0.777T | 0.561T | 0.501T |
| A⁺B⁻C⁺ | 0.670T | 0.570T | 0.770T | 0.740T | 0.520T | 0.770T | 0.670T | 0.570T |
| A⁺B⁻C⁻ | 0.617T | 0.500T | 0.777T | 0.895T | 0.30/0.63 | 0.585T | 0.762T | 0.679T |
| A⁺C⁺B⁺ | 0.783T | 0.693T | 0.383T | 0.911T | 0.583T | 0.384T | 0.782T | 0.694T |
| A⁺C⁻B⁺ | 0.673T | 0.574T | 0.775T | 0.710T | 0.520T | 0.775T | 0.673T | 0.574T |
| B⁺A⁺C⁺ | 0.784T | 0.695T | 0.384T | 0.951T | 0.586T | 0.384T | 0.783T | 0.695T |
| B⁺A⁻C⁺ | 0.673T | 0.574T | 0.774T | 0.739T | 0.520T | 0.775T | 0.673T | 0.574T |

Therefore, the power conversion circuit in the application can significantly reduce current ripples on the respective phases through reconstruction of the coupling relation between the windings in the three-phase integrated inductor, i.e., setting the reference magnetic flux direction of the middle winding column to be opposite to the reference magnetic flux directions of other winding columns. Moreover, the integrated inductor of the power conversion circuit in the application can achieve good application effects by using the material of alloy powder core (i.e., a core material containing naturally distributed air gaps, such as, High Flux, etc.) and integration of three-phase three-column or three-phase five-column scheme.

Exemplary embodiments of the application are illustrated and described in details. It shall be understood that the application is not limited to the disclosed embodiments, and in contrast, the application aims to cover various modifications and equivalent arrangements included in spirit and scope of the appended claims.

What is claimed is:

1. A power conversion circuit, comprising a three-phase inductor and a switching conversion unit, a first end of an inductor in each phase of the three-phase inductor electrically coupled to a midpoint of a bridge arm in one phase of the switching conversion unit, a second end of the inductor in each phase of the three-phase inductor electrically coupled to one phase of a three-phase AC power source, and the three-phase inductor is integrated into a magnetic assembly, the magnetic assembly comprising:
two magnetic yokes relatively parallel to each other;
a first winding column, a second winding column and a third winding column spaced apart sequentially and located between the two magnetic yokes, the second winding column located between the first winding column and the third winding column; and
three windings wound around the first winding column, the second winding column and the third winding column in one-to-one correspondence for forming the inductor in one phase of the three-phase inductor respectively, and phase differences between power frequency currents flowing in any two of the three windings are 120°;
wherein when a reference current is applied to each of the three windings, the reference current flows in from the first end of each of the three windings and flows out from the second end, magnetic fluxes excited by the reference current on the first winding column and the third winding column have a first reference direction, and a magnetic flux excited on the second winding column has a second reference direction, wherein the second reference direction is opposite to the first reference direction.

2. The power conversion circuit according to claim 1, wherein the magnetic assembly further comprises:
an additional column located between the two magnetic yokes.

3. The power conversion circuit according to claim 2, wherein the additional column is made of alloy powder core.

4. The power conversion circuit according to claim 3, wherein a relative magnetic permeability of the alloy powder core is less than or equal to 200.

5. The power conversion circuit according to claim 2, wherein the additional column is made of a material with high magnetic permeability containing air gaps.

6. The power conversion circuit according to claim 5, wherein a relative magnetic permeability of the material with high magnetic permeability is greater than or equal to 500.

7. The power conversion circuit according to claim 1, wherein the three windings are wound around the first winding column, the second winding column and the third winding column in the same manner.

8. The power conversion circuit according to claim 1, wherein the magnetic assembly further comprises:
a first additional column disposed between the first winding column and the second winding column; and
a second additional column disposed between the second winding column and the third winding column.

9. The power conversion circuit according to claim 8, wherein the first additional column and the second additional column are made of alloy powder core.

10. The power conversion circuit according to claim 9, wherein a relative magnetic permeability of the alloy powder core is less than or equal to 200.

11. The power conversion circuit according to claim 8, wherein the first additional column and the second additional column are made of a material with high magnetic permeability containing air gaps.

12. The power conversion circuit according to claim 11, wherein a relative magnetic permeability of the material with high magnetic permeability is greater than or equal to 500.

13. The power conversion circuit according to claim 1, wherein the magnetic assembly further comprises:
a first additional column disposed on an outer side of the first winding column; and
a second additional column disposed on an outer side of the third winding column.

14. The power conversion circuit according to claim 13, wherein the first additional column and the second additional column are made of alloy powder core.

15. The power conversion circuit according to claim 14, wherein a relative magnetic permeability of the alloy powder core is less than or equal to 200.

16. The power conversion circuit according to claim 13, wherein the first additional column and the second additional column are made of a material with high magnetic permeability containing air gaps.

17. The power conversion circuit according to claim 16, wherein a relative magnetic permeability of the material with high magnetic permeability is greater than or equal to 500.

18. The power conversion circuit according to claim 1, wherein the first winding column, the second winding column and the third winding column are made of alloy powder core or a material with high magnetic permeability containing air gaps.

19. The power conversion circuit according to claim 1, wherein the two magnetic yokes, the first winding column, the second winding column and the third winding column are made of alloy powder core.

20. The power conversion circuit according to claim 19, wherein a relative magnetic permeability of the alloy powder core is less than or equal to 200.

21. The power conversion circuit according to claim 1, wherein the power conversion circuit is an inverter circuit or a power factor correction circuit.
